(19) United States
(12) Patent Application Publication
(10) Pub. No.: US 2025/0269649 A1
(43) Pub. Date: Aug. 28, 2025

(54) IMAGE FORMING APPARATUS AND NOZZLE INSPECTION METHOD CAPABLE OF IMPROVING ACCURACY IN DETERMINING WHETHER OR NOT NOZZLES WITH BENT TRAJECTORIES ARE PRESENT

(71) Applicant: KYOCERA Document Solutions Inc., Osaka (JP)

(72) Inventor: Shinji Nakatsuka, Osaka (JP)

(21) Appl. No.: 19/060,630

(22) Filed: Feb. 21, 2025

(30) Foreign Application Priority Data
Feb. 26, 2024 (JP) 2024-026114

(51) Int. Cl. B41J 2/165; B41J 2/21; B41J 29/393

(52) U.S. Cl. CPC B41J 2/16579; B41J 2/2142; B41J 29/393

(57) ABSTRACT

An image forming apparatus includes an ejection portion, a formation processing portion, an acquisition processing portion, and a determination processing portion. The ejection portion includes a plurality of nozzles and ejects ink from each of the nozzles. The formation processing portion forms, on a sheet, acquisition images including a first acquisition image used to acquire a number of the nozzles in an abnormal state and a second acquisition image used to acquire a number of the nozzles in a non-ejecting state among abnormal states. The acquisition processing portion acquires the number of the nozzles in the abnormal state and the number of the nozzles in the non-ejecting state based on a result of reading the acquisition images. The determination processing portion, based on the results obtained by the acquisition processing portion, determines whether or not there is a nozzle in a bent trajectory state among abnormal states.

### INCORPORATION BY REFERENCE

This application is based upon and claims the benefit of priority from the corresponding Japanese Patent Application No. 2024-026114 filed on Feb. 26, 2024, the entire contents of which are incorporated herein by reference.

### BACKGROUND

The present disclosure relates to an image forming apparatus and a nozzle inspection method.

An image forming apparatus that forms an image by an inkjet method includes an ejection portion such as a line head. The ejection portion includes a plurality of nozzles arranged along a width direction perpendicular to a conveying direction of a sheet, and ejects ink from each of the nozzles.

In addition, an image forming apparatus capable of determining whether there is a nozzle in an abnormal state is known as related art. More specifically, in the image forming apparatus of the related art, the ejection portion is used to form a first determination image used to determine whether or not there is a nozzle in an abnormal state, and a second determination image used to determine whether or not there is a nozzle that, among abnormal states, is in a non-ejecting state unable to eject ink. Based on the result of reading the formed first determination image, it is determined whether or not there is a nozzle in an abnormal state. In addition, in a case in which it is determined that there is a nozzle in an abnormal state, it is then determined, based on the results of reading the formed second determination image, whether there is a nozzle in a non-ejecting state or a nozzle in a bent trajectory state in which the trajectory of the ejected ink is bent.

### SUMMARY

An image forming apparatus according to one aspect of the present disclosure includes an ejection portion, a formation processing portion, a reading processing portion, an acquisition processing portion, and a determination processing portion. The ejection portion includes a plurality of nozzles arranged along a width direction perpendicular to a conveying direction of a sheet, and ejects ink from each of the nozzles. The formation processing portion forms, on a sheet, acquisition images including a first acquisition image used to acquire a number of the nozzles in an abnormal state and a second acquisition image used to acquire a number of the nozzles in a non-ejecting state among abnormal states. The reading processing portion reads the acquisition image formed on the sheet. The acquisition processing portion acquires the number of the nozzles in the abnormal state and the number of the nozzles in the non-ejecting state based on a result of reading the acquisition images by the reading processing portion. The determination processing portion, based on the results obtained by the acquisition processing portion, determines whether or not there is a nozzle in a bent trajectory state among abnormal states.

A nozzle inspection method according to another aspect of the present disclosure is executed by an image forming apparatus that includes an ejection portion including a plurality of nozzles arranged along a width direction perpendicular to a conveying direction of a sheet, and configured to eject ink from each of the nozzles, and includes a formation step, a reading step, an acquisition step, and a determination step. In the formation step, the ejection portion is used to form, on the sheet, acquisition images including a first acquisition image used to acquire the number of nozzles in an abnormal state and a second acquisition image used to acquire the number of nozzles in a non-ejecting state among abnormal states. In the reading step, the acquisition images formed on the sheet are read. In the acquisition step, the number of the nozzles in the abnormal state and the number of the nozzles in the non-ejecting state are acquired based on a reading result by the reading step. In the determination step, whether or not there is a nozzle in a bent trajectory state among abnormal states is determined based on the acquisition results acquired by the acquisition step.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view showing a configuration of an image forming apparatus of an embodiment according to the present disclosure.

FIG. 2 is a plan view showing a configuration of an image forming portion and a conveying unit of an image forming apparatus of an embodiment according to the present disclosure.

FIG. 3 is a cross-sectional view showing a configuration around a nozzle of an image forming apparatus of an embodiment according to the present disclosure.

FIG. 4 is a block diagram showing a system configuration of an image forming apparatus of an embodiment according to the present disclosure.

FIG. 5 is a diagram showing an example of an acquisition image to be formed by the image forming apparatus of an embodiment according to the present disclosure.

FIG. 6 is a flowchart showing an example of a nozzle inspection process executed by the image forming apparatus of an embodiment according to the present disclosure.

FIG. 7 is a block diagram showing a system configuration of an image forming apparatus according to another embodiment according to the present disclosure.

### DETAILED DESCRIPTION

Hereinafter, an embodiment according to the present disclosure will be described with reference to the accompanying drawings. Note that the following embodiment is an example of a technique according to the present disclosure and does not limit the technical scope of the present disclosure.

### Configuration of Image Forming Apparatus 1

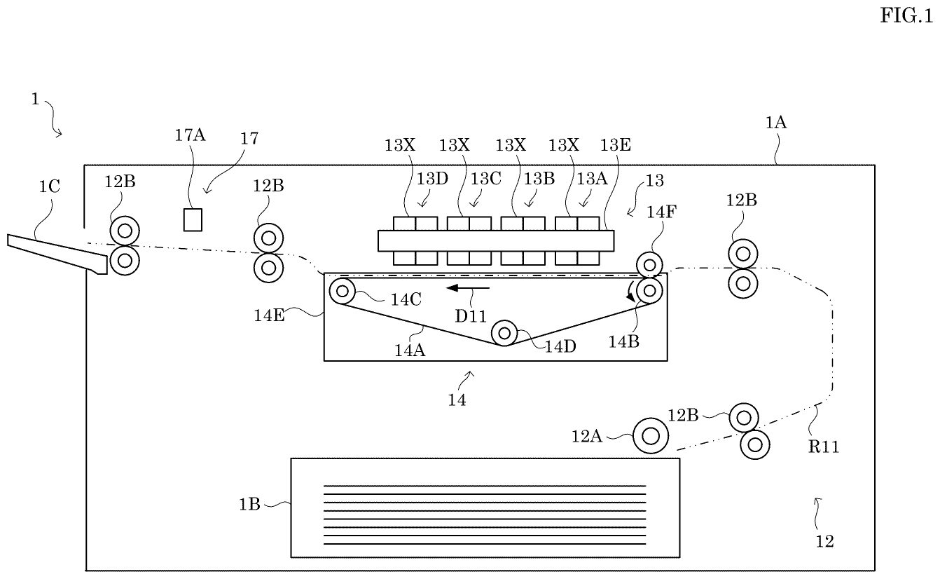

First, a configuration of an image forming apparatus 1 of an embodiment according to the present disclosure will be described with reference to FIGS. 1 to 4. Note that in FIG. 1, a sheet conveying path R11 is indicated by a two-dot chain line.

The image forming apparatus 1 is a printer capable of forming an image on a sheet by an inkjet method. The image forming apparatus 1 may be a fax machine, a copier, a multifunction peripheral, or the like capable of forming an image on a sheet by an inkjet method.

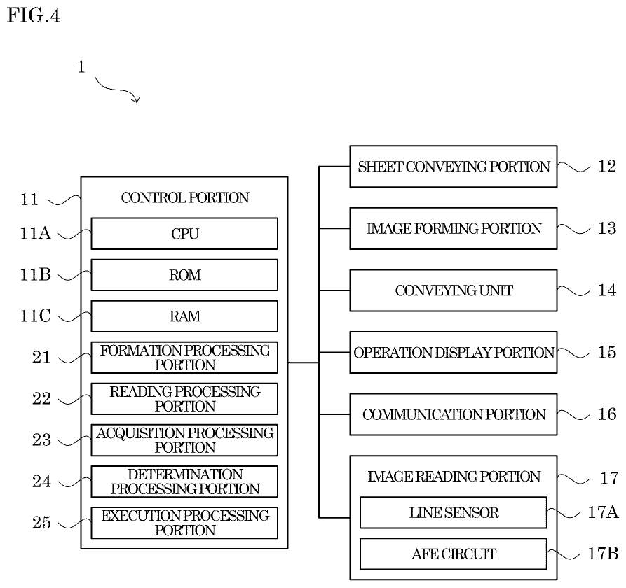

As shown in FIG. 4, the image forming apparatus 1 includes a control portion 11, a sheet conveying portion 12, an image forming portion 13, a conveying unit 14, an operation display portion 15, a communication portion 16, and an image reading portion 17. In addition, the image forming apparatus 1 includes a housing 1A shown in FIG. 1.

The housing 1A houses each of the components of the image forming apparatus 1. A sheet feed cassette 1B is detachably provided in the housing 1A. The sheet feed cassette 1B stores sheets on which images are to be formed. A sheet discharge tray 1C is provided on an outer-side surface of the housing 1A. A sheet on which an image has been formed by the image forming portion 13 is discharged to the sheet discharge tray 1C. Inside the housing 1A, a sheet stored in a sheet feed cassette 1B is conveyed along the sheet conveying path R11 (see FIG. 1) that passes through an image forming position of the image forming portion 13 and reaches the sheet discharge tray 1C.

The control portion 11 performs overall control of the image forming apparatus 1. As shown in FIG. 4, the control portion 11 includes a CPU 11A, a ROM 11B, and a RAM 11C. The CPU 11A is a processor that executes various types of arithmetic processing. The ROM 11B is a non-volatile storage device in which information such as control programs for causing the CPU 11A to execute various types of processes is stored in advance. The RAM 11C is a volatile or non-volatile storage device used as a temporary storage memory (work area) for various types of processes executed by the CPU 11A. The CPU 11A executes various types of control programs stored in advance in the ROM 11B. Thus, the CPU 11A performs overall control of the image forming apparatus 1.

The sheet conveying portion 12 conveys sheets stored in the sheet feed cassette 1B along the sheet conveying path R11 (see FIG. 1). As shown in FIG. 1, the sheet conveying portion 12 includes a pick-up roller 12A and a plurality of conveying rollers 12B. The pick-up roller 12A picks up the top sheet of a sheet stack stored in the sheet feed cassette 1B, and feeds the sheet out to the sheet conveying path R11. The plurality of conveying rollers 12B are arranged side by side along the sheet conveying path R11. Each of the conveying rollers 12B conveys the sheet along the sheet conveying path R11. Each of the conveying rollers 12B conveys a sheet in a conveying direction D11 (see FIG. 1) from the sheet feed cassette 1B toward the sheet discharge tray 1C.

The image forming portion 13 forms an image on the sheet supplied from the sheet conveying portion 12 based on image data. As shown in FIG. 1, the image forming portion 13 includes line heads 13A to 13D and a head frame 13E.

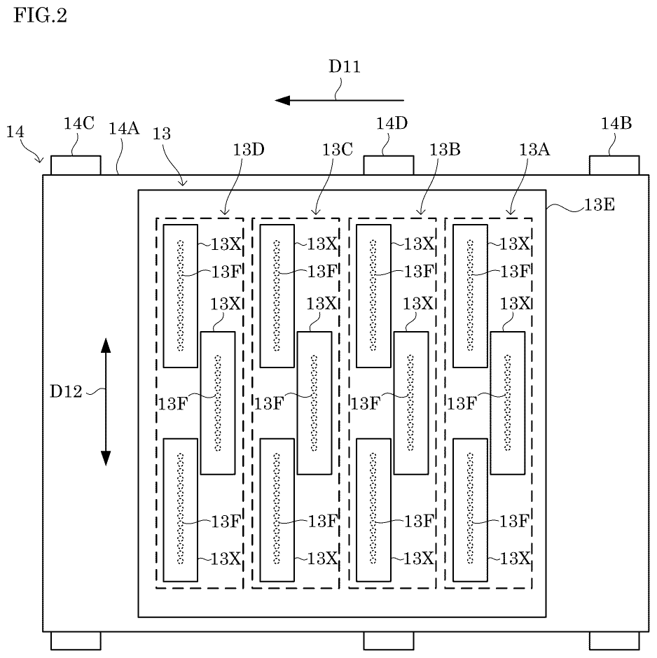

As shown in FIG. 2, each of the line heads 13A to 13D is elongated in a width direction D12 perpendicular to the conveying direction D11 of the sheet by the sheet conveying portion 12. More specifically, each of the line heads 13A to 13D has a length in the width direction D12 that corresponds to the width of the largest size sheet that can be accommodated in the sheet feed cassette 1B. The line heads 13A to 13D are arranged side by side at equal intervals along the conveying direction D11.

The line head 13A ejects black ink toward the sheet being conveyed by the conveying unit 14. The line head 13B ejects cyan ink toward the sheet being conveyed by the conveying unit 14. The line head 13C ejects magenta ink toward the sheet being conveyed by the conveying unit 14. The line head 13D ejects yellow ink toward the sheet being conveyed by the conveying unit 14.

The line heads 13B to 13D have a common configuration with the line head 13A, except that the colors of ink ejected are different. Hereinafter, only the line head 13A will be described.

As shown in FIG. 2, the line head 13A has three recording heads 13X. Each of the recording heads 13X is elongated in the width direction D12. The three recording heads 13X are arranged in a staggered pattern along the width direction D12.

A plurality of nozzles 13F (see FIG. 2) are provided on the surface of each of the recording heads 13X that faces the sheet. In each of the recording heads 13X, the plurality of nozzles 13F are arranged along the width direction D12. More specifically, in each of the recording heads 13X, the plurality of nozzles 13F are arranged along the width direction D12 at a density corresponding to a printing resolution of the image forming apparatus 1. For example, the plurality of nozzles 13F are arranged side by side at equal intervals along the width direction D12. That is, each of the recording heads 13X has a nozzle row formed by a plurality of nozzles 13F aligned at equal intervals along the width direction D12. Each of the recording heads 13X may have a plurality of nozzle rows aligned along the conveying direction D11.

All the nozzles 13F included in the line head 13A are arranged along the width direction D12. More specifically, the three recording heads 13X included in the line head 13A are arranged in a staggered pattern along the width direction D12 so that all the nozzles 13F included in the line head 13A are arranged along the width direction D12 at a density corresponding to the printing resolution of the image forming apparatus 1. The line head 13A ejects ink from each of the nozzles 13F. The line head 13A is an example of an ejection portion described in the present disclosure. In addition, the plurality of nozzles 13F included in the line head 13A are an example of the plurality of nozzles described in the present disclosure.

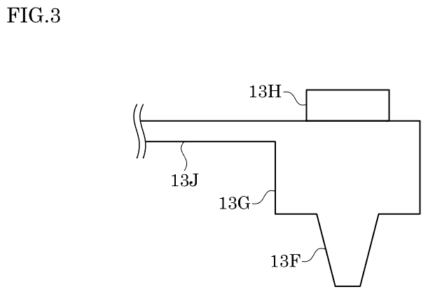

Each of the recording heads 13X includes a pressure chamber 13G (see FIG. 3), an ejection element 13H (see FIG. 3), and an individual flow path 13J (see FIG. 3) corresponding to each of the nozzles 13F. The pressure chamber 13G communicates with the nozzle 13F and stores ink. The ejection element 13H ejects ink from the nozzle 13F in response to an applied drive voltage. The ejection element 13H is a piezoelectric element. More specifically, a drive signal including an ON state in which the drive voltage is applied and an OFF state in which the drive voltage is not applied is input to the ejection element 13H. The ejection element 13H, by changing the pressure in the pressure chamber 13G in response to the input of the drive signal, ejects ink from the nozzle 13F. The individual flow path 13J is an ink flow path provided between the pressure chamber 13G and a common flow path (not shown) shared by the plurality of nozzles 13F. The plurality of individual flow paths 13J corresponding to the plurality of nozzles 13F are connected to the common flow path. The common flow path is connected to an ink supply portion (not shown) that supplies ink to each of the pressure chambers 13G. The ejection element 13H may be a thermoelectric element or the like.

The head frame 13E supports the line heads 13A to 13D. The head frame 13E is supported by the housing 1A. Note that the number of line heads provided in the image forming portion 13 may be one or more. In addition, the number of recording heads 13X provided in each of the line heads 13A to 13D does not need to be limited to three.

As shown in FIG. 1, the conveying unit 14 is arranged below the line heads 13A to 13D. The conveying unit 14 conveys the sheet while facing the recording head 13X. For example, the conveying unit 14 conveys the sheet by a predetermined conveying amount every time the recording heads 13X eject ink. In addition, the conveying unit 14 stops conveying the sheet while the recording heads 13X are ejecting ink. As shown in FIG. 1, the conveying unit 14 includes a conveying belt 14A on which a sheet is placed, a first tension roller 14B, a second tension roller 14C, and a third tension roller 14D that apply tension to the transport belt 14A, and a conveying frame 14E that supports these. Note that a gap between the conveying belt 14A and the recording head 13X is adjusted so that the gap between the surface of the sheet and the recording head 13X during image formation is a predetermined distance (for example, 1 mm).

The first tension roller 14B is rotationally driven by a rotational driving force supplied from a motor (not shown). Thus, the conveying belt 14A rotates in a direction capable of conveying the sheet in the conveying direction D11 (see FIG. 1). Note that the conveying unit 14 is also provided with a suction unit (not shown) that sucks air through a plurality of through holes formed in the conveying belt 14A in order to attract the sheet to the conveying belt 14A. In addition, a pressure roller 14F (see FIG. 1) is provided above the first tension roller 14B to press the sheet against the conveying belt 14A for conveying.

The operation display portion 15 is a user interface of the image forming apparatus 1. The operation display portion 15 includes a display portion and an operation portion. The display portion displays various types of information in response to control instructions from the control portion 11. For example, the display portion is a flat panel display such as a liquid crystal display. The operation portion inputs various types of information to the control portion 11 in response to a user operation. For example, the operation portion includes operation keys and a touch panel.

The communication portion 16 is a communication interface that executes wired or wireless data communication with an external communication device such as a personal computer.

The image reading portion 17 reads an image formed on the sheet by the image forming portion 13.

As shown in FIGS. 1 and 4, the image reading portion 17 includes a line sensor 17A and an analog front-end (AFE) circuit 17B.

As shown in FIG. 1, the line sensor 17A is provided on the sheet conveying path R11 farther on the downstream side in the conveying direction D11 than the image forming portion 13. The line sensor 17A is capable of reading an image of one line along the main scanning direction, which is the same direction as the width direction D12 (see FIG. 2), from a sheet passing through an arrangement position of the line sensor 17A on the sheet conveying path R11. For example, the line sensor 17A is a contact image sensor (CIS). The line sensor 17A includes a plurality of imaging elements arranged side by side in the width direction D12. Each of the imaging elements includes a light emitting portion and a light receiving portion. The light emitting portion emits light toward the sheet conveyed along the sheet conveying path R11. The light receiving portion is provided to be capable of receiving light emitted from the light emitting portion and reflected by the sheet, and outputs an analog electrical signal according to an amount of received light. In response to a control signal input from the control portion 11, the line sensor 17A outputs an analog electrical signal corresponding to an image of one line along the main scanning direction at predetermined intervals.

The AFE circuit 17B is an electronic circuit that executes a predetermined process on the analog electrical signal output from the line sensor 17A. More specifically, the AFE circuit 17B includes a signal conversion portion that converts the analog electrical signal output from the line sensor 17A into a digital electrical signal (image data). In addition, the AFE circuit 17B also includes an image processing portion that executes predetermined image processing such as shading correction on the image data output from the signal conversion portion. The AFE circuit 17B outputs to the control portion 11 the image data that has been subjected to the image processing and that is output from the image processing portion.

An image forming apparatus capable of determining whether or not there is a nozzle 13F in an abnormal state is known as related art. More specifically, in the image forming apparatus of the related art, a line head 13A is used to form a first determination image used to determine whether or not there is a nozzle 13F in an abnormal state, and a second determination image used to determine whether or not there is a nozzle 13F that, among abnormal states, is in a non-ejecting state unable to eject inkjet. Based on the result of reading the formed first determination image, it is determined whether or not there is a nozzle 13F in an abnormal state. In addition, in a case in which it is determined that there is a nozzle in an abnormal state, it is then determined, based on the results of reading the formed second determination image, whether or not there is a nozzle 13F in a non-ejecting state or a nozzle 13F in a bent trajectory state in which the trajectory of the ejected ink is bent.

However, in the image forming apparatus according to the related art, it is determined that there is a nozzle 13F in a bent trajectory state only when it is determined that there is a nozzle 13F in an abnormal state and that there is no nozzle 13F in a non-ejecting state. Therefore, in a case in which there are both a nozzle 13F in a non-ejecting state and a nozzle 13F in a bent trajectory state, it cannot be determined that there is a nozzle 13F in a bent trajectory state.

In contrast, in the image forming apparatus 1 of an embodiment according to the present disclosure, as will be described below, it is possible to improve the accuracy of determining whether or not there is a nozzle 13F in a bent trajectory state.

A method for inspecting the nozzles 13F of the line head 13A that is executed by the image forming apparatus 1 will be described below. Note that in the image forming apparatus 1, a method for inspecting the nozzles 13F of the other line heads is also executed; however, since the method is basically the same as the method for inspecting the nozzles 13F of the line head 13A, a description thereof will be omitted.

As shown in FIG. 4, the control portion 11 includes a formation processing portion 21, a reading processing portion 22, an acquisition processing portion 23, a determination processing portion 24, and an execution processing portion 25.

More specifically, a nozzle inspection program for causing the CPU 11A to function as each of the processing portions shown in FIG. 4 is stored in advance in the ROM 11B of the control portion 11. The CPU 11A, by executing the nozzle inspection program, functions as each of the processing portions described above.

Note that the nozzle inspection program may be recorded on a computer-readable recording medium such as a CD, DVD, or flash memory, and may be read from the recording medium and stored in a non-volatile storage device provided in the image forming apparatus 1. In addition, the nozzle inspection program may be a program for causing a plurality of processors to function as each of the processing portions shown in FIG. 4. Furthermore, some or all of the processing portions included in the control portion 11 may be configured with electronic circuits.

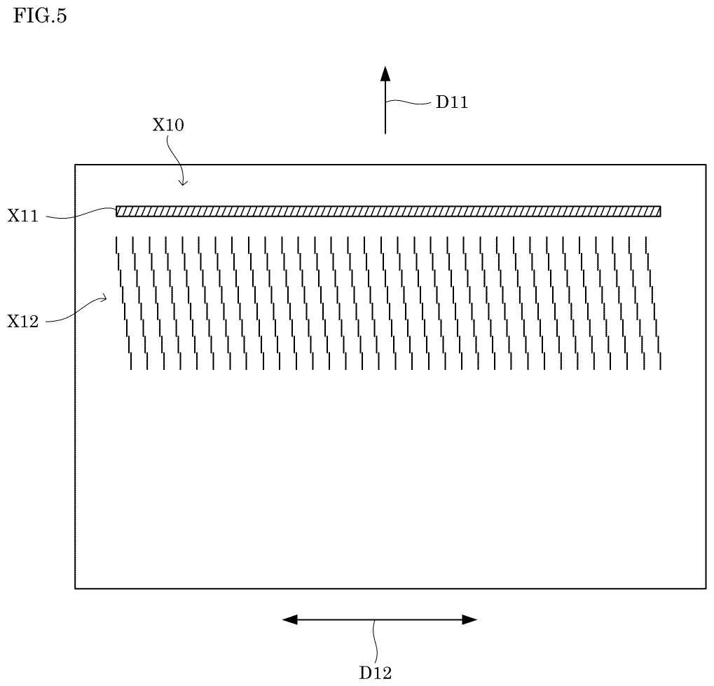

The formation processing portion 21 uses the line head 13A to form on a sheet an acquisition image X10 (see FIG. 5) that includes a first acquisition image X11 (see FIG. 5) used to acquire the number of nozzles 13F in an abnormal state, and a second acquisition image X12 (see FIG. 5) used to acquire the number of nozzles 13F in a non-ejecting state.

FIG. 5 shows an example of an acquisition image X10. Note that in FIG. 5, the first acquisition image X11 is hatched.

The first acquisition image X11 is an image formed using all the nozzles 13F included in the line head 13A. More specifically, as shown in FIG. 5, the first acquisition image X11 is a long, strip-shaped solid image along the width direction D12. In a case in which the line head 13A includes a nozzle 13F in an abnormal state, a white stripe appears along the conveying direction D11 in the first acquisition image X11 formed on the sheet.

The second acquisition image X12 is an image formed using all the nozzles 13F included in the line head 13A. For example, as shown in FIG. 5, the second acquisition image X12 includes elongated line images formed by each of the nozzles 13F in the conveying direction D11 corresponding to each of the nozzles 13F. In a case in which the line head 13A does not include a nozzle 13F in a non-ejecting state, the second acquisition image X12 formed on the sheet includes the same number of line images as the number of nozzles 13F included in the line head 13A.

The reading processing portion 22 reads the acquisition image X10 formed on the sheet.

For example, the reading processing portion 22 uses the image reading portion 17 to read the acquisition image X10 formed on the sheet.

The reading processing portion 22 may read the acquisition image X10 formed on the sheet using a scanner communicably connected to the image forming apparatus 1.

The acquisition processing portion 23 acquires the number of nozzles 13F in an abnormal state and the number of nozzles 13F in a non-ejecting state based on the reading result by the reading processing portion 22.

More specifically, the acquisition processing portion 23 detects white stripes along the conveying direction D11 from the read image of the first acquisition image X11 formed on the sheet. The acquisition processing portion 23 then acquires the number of detected white stripes as the number of nozzles 13F in an abnormal state.

In addition, the acquisition processing portion 23 counts the number of line images included in the read image of the second acquisition image X12 formed on the sheet. The acquisition processing portion 23 acquires the difference between the number of nozzles 13F included in the line head 13A and the count number of the line image as the number of nozzles 13F in a non-ejecting state.

The determination processing portion 24, based on the results obtained by the acquisition processing portion 23, determines whether or not there is a nozzle in a bent trajectory state among abnormal states.

More specifically, the determination processing portion 24 determines that there is a nozzle 13F in a bent trajectory state when the number of nozzles 13F in an abnormal state is different from the number of nozzles 13F in a non-ejecting state. In addition, in a case in which the number of nozzles 13F in an abnormal state is the same as the number of nozzles 13F in a non-ejecting state, the determination processing portion 24 determines that there are no nozzles 13F in a bent trajectory state.

When the determination processing portion 24 determines that there is a nozzle 13F in a bent trajectory state, the execution processing portion 25 executes a second detection process (an example of a detection process according to the present disclosure) for detecting a nozzle 13F in a bent trajectory state.

For example, in the second detection process, a detection image used for detecting a nozzle 13F in the bent trajectory state is formed on the sheet. Based on the result of reading the detection image formed on the sheet by the image reading portion 17, each of the nozzles 13F included in the line head 13A in a bent trajectory state is detected. That is, a position of each of the nozzles 13F in the line head 13A in a bent trajectory state is identified.

### Nozzle Inspection Process

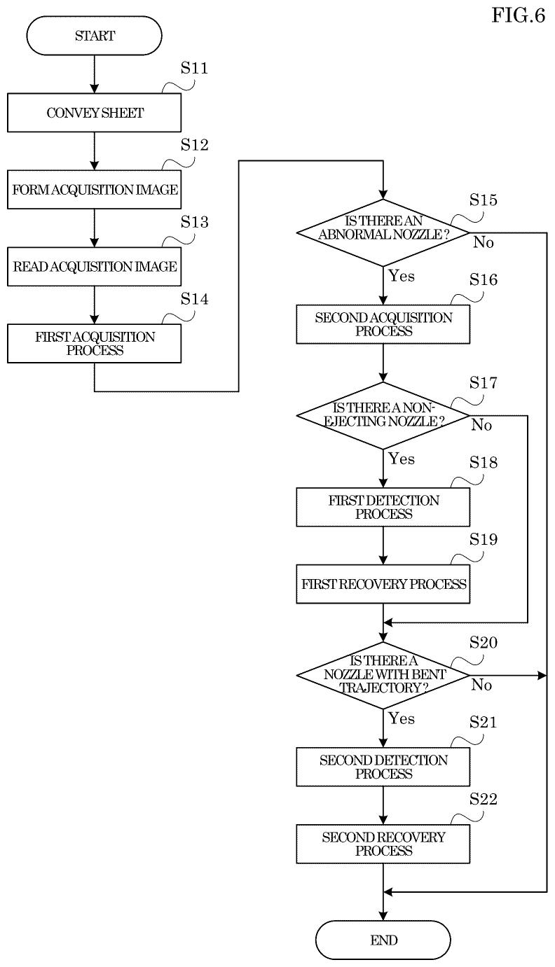

Hereinafter, with reference to FIG. 6, an example of a procedure of the nozzle inspection process executed by the control portion 11 in the image forming apparatus 1 and the nozzle inspection method according to the present disclosure will be described. Here, steps S11, S12, . . . represent numbers of processing procedures (steps) executed by the control portion 11. For example, the nozzle inspection process is executed when a command to execute the nozzle inspection process is input by a user operation on the operation display portion 15.

### Step S11

First, in step S11, the control portion 11 conveys a sheet along the sheet conveying path R11.

### Step S12

In step S12, the control portion 11 uses the line head 13A to form an acquisition image X10 (see FIG. 5) on the sheet conveyed in the process of step S11. The process of step S12 is an example of a formation step according to the present disclosure, and is executed by the formation processing portion 21 of the control portion 11.

### Step S13

In step S13, the control portion 11 uses the image reading portion 17 to read the acquisition image X10 formed on the sheet in the process of step S12. The process of step S13 is an example of a reading step according to the present disclosure, and is executed by the reading processing portion 22 of the control portion 11.

### Step S14

In step S14, the control portion 11 executes a first acquisition process to acquire the number of the nozzles 13F in an abnormal state based on the result of the process in step S13.

More specifically, in the first acquisition process, white stripes along the conveying direction D11 are detected from a read image of the first acquisition image X11 formed on the sheet. The number of detected white stripes is acquired as the number of nozzles 13F in the abnormal state.

### Step S15

In step S15, the control portion 11 determines whether or not there is a nozzle 13F in the abnormal state.

More specifically, the control portion 11 determines that there is a nozzle 13F in the abnormal state when the number of nozzles 13F in the abnormal state acquired in the first acquisition process is one or more.

Here, when the control portion 11 determines that there is a nozzle 13F in the abnormal state (Yes side of S15), the control portion 11 moves processing to the process of step S16. In addition, when there is no nozzle 13F in the abnormal state (No in S15), the control portion 11 ends the nozzle inspection process.

### Step S16

In step S16, the control portion 11 executes a second acquisition process to acquire the number of nozzles 13F in the non-ejecting state based on the result of the process in step S13. The processes of step S14 and step S16 are examples of an acquisition step according to the present disclosure, and are executed by the acquisition processing portion 23 of the control portion 11.

More specifically, in the second acquisition process, the number of line images included in the read image of the second acquisition image X12 formed on the sheet is counted. The difference between the number of nozzles 13F included in the line head 13A and the count number of the line images is acquired as the number of nozzles 13F in the non-ejecting state.

### Step S17

In step S17, the control portion 11 determines whether or not there is a nozzle 13F in the non-ejecting state.

More specifically, the control portion 11 determines that there is a nozzle 13F in the non-ejecting state when the number of nozzles 13F in the non-ejecting state acquired in the second acquisition process is one or more.

Here, when the control portion 11 determines that there is a nozzle 13F in the non-ejecting state (Yes side of S17), the control portion 11 moves processing to step S18. In addition, when there is no nozzle 13F in the non-ejecting state (No in S17), the control portion 11 moves processing to step S20.

### Step S18

In step S18, the control portion 11 executes a first detection process for detecting nozzles 13F in the non-ejecting state.

More specifically, in the first detection process, a line image forming area corresponding to each nozzle 13F is set for the read image of the second acquisition image X12 formed on the sheet. The line image forming area is an area having a size capable of including the line image. In addition, in the first detection process, it is determined whether or not each of the line image forming areas includes the line image. When the line image forming area that does not include the line image is detected, the nozzle 13F corresponding to the line image forming area is determined to be a nozzle 13F in the non-ejecting state.

### Step S19

In step S19, the control portion 11 executes a first recovery process for recovering an ejecting function of the nozzle 13F that is in the non-ejecting state.

For example, in the first recovery process, a purge process is executed to forcibly eject ink from the nozzles 13F in the non-ejecting state. Thus, the non-ejecting state caused by clogging of the nozzle 13F is eliminated.

Note that in a case in which the first recovery process is executed, the control portion 11 may cause the operation display portion 15 to display a message indicating that a nozzle 13F in the non-ejecting state has been detected and indicating the position of the nozzle 13F in the non-ejecting state.

### Step S20

In step S20, the control portion 11 determines whether or not there is a nozzle 13F in the bent trajectory state. The process of step S20 is an example of a determination step according to the present disclosure, and is executed by the determination processing portion 24 of the control portion 11.

More specifically, the control portion 11 determines that there is a nozzle 13F in the bent trajectory state when the number of nozzles 13F in the abnormal state acquired in the first acquisition process is greater than the number of nozzles 13F in the non-ejecting state acquired in the second acquisition process.

Here, when the control portion 11 determines that there is a nozzle 13F in the bent trajectory state (Yes side of S20), the control portion 11 moves processing to step S21. In addition, when there is no nozzle 13F in the bent trajectory state (No in S20), the control portion 11 ends the nozzle inspection process.

### Step S21

In step S21, the control portion 11 executes the second detection process to detect the nozzle 13F in the bent trajectory state. The process of step S21 is executed by the execution processing portion 25 of the control portion 11.

### Step S22

In step S22, the control portion 11 executes a second recovery process for recovering the ejecting function of the nozzle 13F in the bent trajectory state.

For example, in the second recovery process, a cleaning process is executed to clean the nozzle face in the vicinity of the nozzle 13F in the bent trajectory state. Thus, the bent trajectory state caused by foreign matter adhering to the nozzle 13F is eliminated.

Note that when the second recovery process is executed, the control portion 11 may cause the operation display portion 15 to display a message indicating that the nozzle 13F in the bent trajectory state has been detected and indicating the position of the nozzle 13F in the bent trajectory state.

In this way, in the image forming apparatus 1, the number of nozzles 13F in the abnormal state and the number of nozzles 13F in the non-ejecting state are obtained, and based on these obtained numbers, it is determined whether or not there are nozzles 13F in the bent trajectory state. Thus, even in a case in which there is both a nozzle 13F in the non-ejecting state and a nozzle 13F in the bent trajectory state, it is possible to determine that there is a nozzle 13F in the bent trajectory state. Therefore, it is possible to improve the accuracy of determining whether or not there is a nozzle 13F in the bent trajectory state.

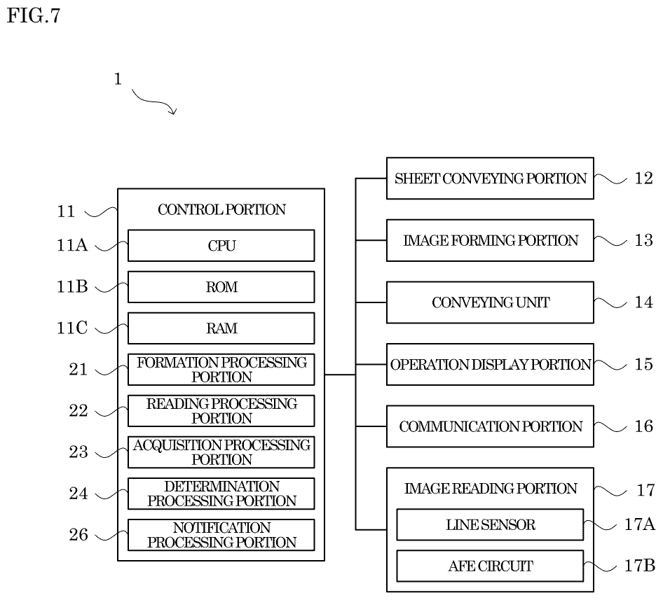

Note that control portion 11 may include a notification processing portion 26 shown in FIG. 7 instead of the execution processing portion 25.

When the determination processing portion 24 determines that there is a nozzle in the bent trajectory state, the notification processing portion 26 issues a notification to that effect.

For example, the notification processing portion 26 causes the operation display portion 15 to display a message indicating that it has been determined that there is a nozzle in the bent trajectory state and that it is recommended to execute the second detection process. Thus, it possible to prompt the user to execute the second detection process.

### Supplementary Notes of the Invention

An outline of the invention extracted from the above-described embodiment will be added below. Note that the configurations and processing functions described in the following supplementary notes can be selected and combined in any desired manner.

### Supplementary Note 1

An image forming apparatus including:
an ejection portion including a plurality of nozzles arranged along a width direction perpendicular to a conveying direction of a sheet, and configured to eject ink from each of the nozzles;
a formation processing portion configured to use the ejection portion to form, on the sheet, acquisition images including a first acquisition image used to acquire a number of the nozzles in an abnormal state and a second acquisition image used to acquire a number of the nozzles in a non-ejecting state among abnormal states;
a reading processing portion configured to read the acquisition images formed on the sheet;
an acquisition processing portion configured to acquire the number of the nozzles in the abnormal state and the number of the nozzles in the non-ejecting state based on a reading result by the reading processing portion; and
a determination processing portion configured to determine whether or not there is a nozzle in a bent trajectory state among the abnormal states, based on an acquisition result obtained by the acquisition processing portion.

### Supplementary Note 2

The image forming apparatus according to Supplementary Note 1, including
an execution processing portion configured to execute a detection process to detect the nozzle in the bent trajectory state when the determination processing portion determines that there is a nozzle in the bent trajectory state.

### Supplementary Note 3

The image forming apparatus according to Supplementary Note 1, including
a notification processing portion configured to, when it is determined by the determination processing portion that there is the nozzle in the bent trajectory state, issue a notification to that effect.

### Supplementary Note 4

A nozzle inspection method that is executed in an image forming apparatus that includes an ejection portion including a plurality of nozzles arranged along a width direction perpendicular to a conveying direction of a sheet, and configured to eject ink from each of the nozzles,
the nozzle inspection method including:
a formation step of using the ejection portion to form, on the sheet, acquisition images including a first acquisition image used to acquire a number of the nozzles in an abnormal state and a second acquisition image used to acquire a number of the nozzles in a non-ejecting state among abnormal states;
a reading step of reading the acquisition images formed on the sheet;
an acquisition step of acquiring the number of the nozzles in the abnormal state and the number of the nozzles in the non-ejecting state based on a reading result by the reading step; and
a determination step of determining whether or not there is a nozzle in a bent trajectory state among the abnormal states, based on an acquisition result obtained by the acquisition step.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an ejection portion including a plurality of nozzles arranged along a width direction perpendicular to a conveying direction of a sheet, and configured to eject ink from each of the nozzles;
a formation processing portion configured to use the ejection portion to form, on the sheet, acquisition images including a first acquisition image used to acquire a number of the nozzles in an abnormal state and a second acquisition image used to acquire a number of the nozzles in a non-ejecting state among abnormal states;
a reading processing portion configured to read the acquisition images formed on the sheet;
an acquisition processing portion configured to acquire the number of the nozzles in the abnormal state and the number of the nozzles in the non-ejecting state based on a reading result by the reading processing portion; and
a determination processing portion configured to determine whether or not there is a nozzle in a bent trajectory state among the abnormal states, based on an acquisition result obtained by the acquisition processing portion.

2. The image forming apparatus according to claim 1, comprising
an execution processing portion configured to execute a detection process to detect the nozzle in the bent trajectory state when the determination processing portion determines that there is a nozzle in the bent trajectory state.

3. The image forming apparatus according to claim 1, comprising
a notification processing portion configured to, when it is determined by the determination processing portion that there is the nozzle in the bent trajectory state, issue a notification to that effect.

4. A nozzle inspection method that is executed in an image forming apparatus that comprises an ejection portion including a plurality of nozzles arranged along a width direction perpendicular to a conveying direction of a sheet, and configured to eject ink from each of the nozzles,
the nozzle inspection method comprising:
a formation step of using the ejection portion to form, on the sheet, acquisition images including a first acquisition image used to acquire a number of the nozzles in an abnormal state and a second acquisition image used to acquire a number of the nozzles in a non-ejecting state among abnormal states;
a reading step of reading the acquisition images formed on the sheet;
an acquisition step of acquiring the number of the nozzles in the abnormal state and the number of the nozzles in the non-ejecting state based on a reading result by the reading step; and
a determination step of determining whether or not there is a nozzle in a bent trajectory state among the abnormal states, based on an acquisition result obtained by the acquisition step.
